(19) United States
(12) Patent Application Publication
(10) Pub. No.: US 2024/0032547 A1
(43) Pub. Date: Feb. 1, 2024

(54) MOLDABLE, COLORABLE STORAGE-STABLE, ALLERGEN-FREE COMPOSITION

(71) Applicant: COLORIDOH INC., Menlo Park, CA (US)

(72) Inventor: Hitomi TAKEUCHI, Menlo Park, CA (US)

(21) Appl. No.: 18/038,658

(22) PCT Filed: Nov. 24, 2021
(86) PCT No.: PCT/US2021/060874

§ 371 Date: May 24, 2023

Related U.S. Application Data
(60) Provisional application No. 63/118,528, filed on Nov. 25, 2020.

(51) Int. Cl. A21D 13/066; A21D 10/02; A21D 13/48

(52) U.S. Cl. CPC A21D 13/066; A21D 10/02; A21D 13/48

(57) ABSTRACT

Example implementations described herein are directed to a dough configured to be baked by heat, the dough comprising a gluten-free cereal flour, a sweetener, a shortening, and an emulsifier, wherein the dough is shelf-stable, moldable, edible, allergen-free and vegan.

### CROSS-REFERENCE TO RELATED APPLICATIONS

This application is US National Stage of International Patent Application PCT/US2021/060874, filed Nov. 24, 2021, which claims benefit of priority from U.S. Patent Application 63/118,528, filed Nov. 25, 2020, the contents of both of which are incorporated herein by reference.

### BACKGROUND

### Field

The present disclosure is directed generally to a composition that is moldable, colorable, storage-stable and allergen-free, and a method of making the same.

### Related Art

Related art cookie dough exists that is storage-stable. However, the related art cookie dough has various problems and disadvantages. For example, but not by way of limitation, the related art storage-stable cookie dough includes allergens, such as gluten, nuts, and/or others.

At the same time, the number of children with food allergies (e.g., gluten, nuts and others) continues to increase. When either parents or children have such food allergies, the related art cookie dough is not an option for storage-stable playing and baking. Further, many parents lack the resources or capability to create and bake their own cookie dough from scratch. Further, there is a related art trend toward plant-based and vegan diets for health and ethical reasons.

Further, there is a related art problem of storage and shipping of the related art vegan cookie dough that is not storage-stable, but instead requires refrigeration. Such related art vegan cookie dough is also not suitable for playing at room temperature, because it degrades due to the high temperatures and can no longer retain its texture to be a cookie dough for cooking.

There is a related art storage-stable, apparently vegan cookie dough, which is directed to the production of a traditional cookie. However, this related art cookie dough is not moldable, and cannot be used for playing. Further, the related art storage-stable, apparently vegan cookie dough is not colored into different colors. Additionally, there are allergens in this related art composition. For example, but not by way of limitation, the related art storage-stable, apparently vegan cookie dough includes coconut oil, which is an allergen for some people. Additionally, the main sweetener is sugar. Further, flaxseed and water is used as a substitute for eggs. Due to the presence of water, this related art product is not moldable, and is not suitable for use in playing. Xanthan gum may optionally be used as the related art thickening agent.

Thus, there is an unmet need for an allergen-free, storage-stable cookie dough that is moldable and can be played with, and then baked to make cookies.

### SUMMARY

Aspects of the example implementations include a dough configured to be baked by heat, the dough comprising a gluten-free cereal flour, a sweetener, a shortening, and an emulsifier, wherein the dough is shelf-stable (e.g., storage-stable), moldable, allergen-free and vegan.

According to another aspect, the dough does not include TOP14 ingredients.

According to another aspect, the dough does not include gluten.

According to another aspect, the percent of oil is less than 20% of the composition, preferably, less than 14% to 16% of the composition, and more preferably, about 15% of the composition.

According to another aspect, the dough may be formed in one or more of a plurality of colors by blending an organic food coloring in the dough.

According to another aspect, the dough is configured to be molded in a can.

According to another aspect, the dough is nut-free.

### BRIEF DESCRIPTION OF THE DRAWINGS

FIGS. 1A and 1B illustrates Working Example 1, uncooked doughs A-C, in accordance with an example implementation.

FIGS. 2A and 2B illustrates Working Example 1, cooked doughs A-C, in accordance with an example implementation.

FIGS. 3A and 3B illustrates Working Example 2, uncooked doughs A-D, in accordance with an example implementation.

FIGS. 4A and 4B illustrates Working Example 2, cooked doughs A-D, in accordance with an example implementation.

FIG. 5 illustrates a relationship between percentage of shortening content and dough spread according to the example implementation.

FIGS. 6A and 6B illustrates a variation of Working Example 2, uncooked doughs A-D, in accordance with an example implementation.

FIGS. 7A and 7B illustrates the variation of Working Example 2, cooked doughs A-D, in accordance with an example implementation.

FIGS. 8A and 8B illustrates Working Example 3 (unbaked) in accordance with a second example implementation.

FIGS. 9A and 9B illustrates Working Example 3 (baked) in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. The implementations described herein are also not intended to be limiting, and can be implemented in various ways, depending on the desired implementation. Further, the example implementations described herein can be conducted in singular or in any combination with each other to facilitate the desired implementation, and the present disclosure is not limited to any particular one of the example implementations described herein.

Aspects of the example implementations are directed to a playable dough having at least the following properties. For example, but not by way of limitation, the playable dough may be a toy that is clay-like and moldable. Further, the toy may harden upon heating (e.g., baking), and be edible upon heating. Optionally, the toy may be edible prior to heating.

According to aspects of the “playable cookie dough”, at least the following conditions may be required. First, even if a person playing with cookie dough continues to knead the dough, such as if it were just a toy, there is no significant adverse impact on the usability of the dough for baking. Second, the texture and consistency of the playable cookie dough matches that of clay. Third, the shape and color of the cookie dough does not substantially change, even after baking.

The example implementations may have various benefits and advantages. For example, but not by way of limitation, the playable cookie dough may be stored at room temperature (e.g., no need to worry about storage location, reduce shipping costs, and purchase at the optimal price). Further, food allergy sources may be substantially avoided.

The foregoing conditions, and potential benefits and advantages, the example implementation eliminates gluten in the dough. This is done because gluten is the cause of hardening after over-kneading and baking. Optionally, vinegar may be added to improve shape retention, and optionally maintain vibrant colors, as explained below. Further, coloring may be provided with natural ingredients to make playing safe and enjoyable.

In the present example implementation, the ingredients are selected and balanced so as that playable dough does not lose its shape even after baking, while containing an appropriate amount of oil and free water. For example, the free water activity value may be suppressed to 0.7 percent or less, so that it could be stored at room temperature.

Attributes of the example implementations are described below in greater detail.

First, the playable dough is shelf-stable (e.g., storage-stable). To achieve this property, syrup is used instead of free water. Because free water contributes to the soilage of the related art cookie dough, the present example implementations are directed to reduction of the free water. Instead of free water, bound water is used. For example, but not by way of limitation, a liquid that does not include free water, but may include bound water (e.g., combined water), and may include, but is not limited to, syrup or vinegar. Thus, the cookie dough according to the example implementation only includes liquids hat do not include free water. Because bound water is more stable and does not contribute to spoilage, the cookie dough according to the example implementation is shelf stable.

Second, the playable dough according to the example implementations is moldable over time, and retains a clay-like property substantially without degradation. More specifically, by using shortening (e.g., clarified oil) instead of oil, the playable dough retains its clay-like property.

Third, the playable dough according to the example implementations maintains a stable consistency, and does not become hardened over time. The reason for this property is because the playable dough is gluten-free. Thus, the related art problems experienced by the use of wheat flour are avoided.

Fourth, the playable dough can also be baked, and retain its shape upon baking. More specifically, by having the content of the shortening at about 15%, the shape is retained upon baking.

Example implementations may relate to an edible composition, such as a cookie dough, that can be stored for several months even in a non-refrigerated environment and does not use major allergens. More specifically, the example implementations are colorable and have the consistency of a clay (e.g., moldable), which may be used for playing for infants. For example, but not by way of limitation, the play dough may be formed in various shapes, colors and patterns for play (e.g., sea urchin shaped dough), followed by baking to produce colorful cookies. Accordingly, a plant-based, playable, moldable, colorable, storage-stable cookie is provided that is allergen-free and vegan.

More specifically, aspects of the example implementations are directed to a storage-stable, allergen-free, moldable cookie dough that can be formed in various colors, and molded into various shapes. The cookie dough retains its color and shape after manufacture, such that they can be used as toys for children. The cookie dough does not include allergens (e.g., TOP14 ingredients such as peanuts or peanut derivatives, tree nuts or tree nut derivatives, eggs or egg products, sulfites, shellfish or seafood derivatives, soy or soy derivatives, milk or milk products including lactose, fish products, wheat products such as gluten, grain, germ, farina or the like, cereals and cereal derivatives, monosodium glutamate, artificial colors and AZO dyes). Further, the ingredients are natural ingredients, or derived from natural ingredients. Additionally, a storage stable fabric is provided.

Further details of the example implementations are provided as follows with respect to the composition of the cookie dough. More specifically, a source of spoilage in cookie dough stored at room temperature is the presence of free water. Thus, the example implementations seek to minimize the concentration of free water in the cookie dough. In other words, the free water is removed from the cookie dough to the maximum extent possible, so as to avoid spoilage.

In addition to minimizing the free water content of the cookie dough, it is also necessary to maintain the plasticity of the dough's fabric, so that the cookie dough can be moldable. Instead of using free water, shortening may be used to maintain plasticity, as well as combined water to maintain shelf-stability. For example, but not by way of limitation, related art approaches may attempt to use a higher fat content and artificial additives. However, such related art approaches may have various problems and disadvantages. For example, but not by way of limitation, the related art cookie dough containing a high amount of fat and shortening melts and spreads after firing, which results in shape retention, and decreased moldability.

Aspects of the example implementations are directed to the cookie dough being moldable. More specifically, the cookie dough may be molded into a toy-like element.

The example implementations do not include any artificial additives. Further, the shortening content is about 20% so as to maintain the molded shape after baking, while at the same time maintaining the plasticity of the dough at room temperature. Preferably, the shortening content is 16% or less, more preferably, 14% to 16%, and most preferably, about 15%.

The shortening content of 15% is critical to provide the moldability for the cookie dough. If the shortening content is too low, the cookie dough becomes hard; if there is too much shortening content, the cookies lose their shape after cooking, as illustrated and explained with respect to the working examples below. The reason why less shortening makes them hard is because flour and moisture alone are powerfully linked together, while the shortening pulls them apart in a balanced way.

Additionally, the example implementations employ one or more syrups and natural plants. These ingredients are added to provide a property of plasticity in the cookie dough. More specifically, the example implementations include (e.g., blend) several types of thickeners derived from natural products and emulsifiers derived from natural plants. As noted above, the ingredients do not include allergens, such as those included in TOP14, which is well known to those skilled in the art.

In the example implementations, a syrup is provided as a sweetener that maintains plasticity, so that the cookie dough is moldable. As noted above, the water activity is low (e.g., minimal or no free water) and the viscosity is high. The syrup may include one or more of agave syrup, tapioca syrup, and rice syrup. Because honey is not used, the cookie dough is considered to be vegan. An appropriate amount of syrup may be included (e.g. blended), so that the sweetness of the cookie dough can be calibrated.

Further, to increase the viscosity of the thickener, one or more kinds of natural plant-derived gums may be included (e.g., blended). For example, but not by way of limitation, the thickener may be one or more of guar gum or kitasan gum.

Additionally, the example implementations also include gluten-free cereal flour (e.g., rice flour, sorghum flour, starch, etc.), sugar (e.g., sugar or viscous syrup as disclosed above), vegetable oils and fats (e.g., palm oil shortening, sunflower oil), sunflower emulsifiers (e.g., sunflower lecithin or egg whites and gum), plant-derived food colors, and plant-originating flavors.

The foregoing example implementations may be produced by a process. For example, but not by way of limitation, the process may include, but is not limited to, the following operations. First, the liquid, thickener, and emulsifier are thoroughly mixed, followed by the addition of the shortening. Thereafter, the GF flour mix and other ingredients are added, and mixed thoroughly.

### Working Example 1

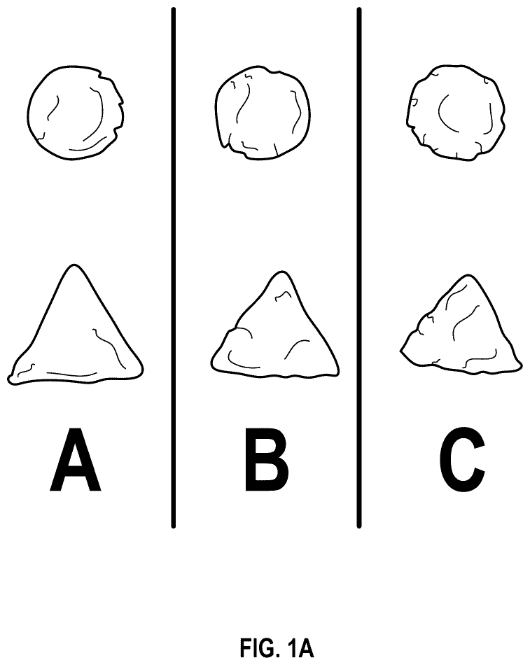

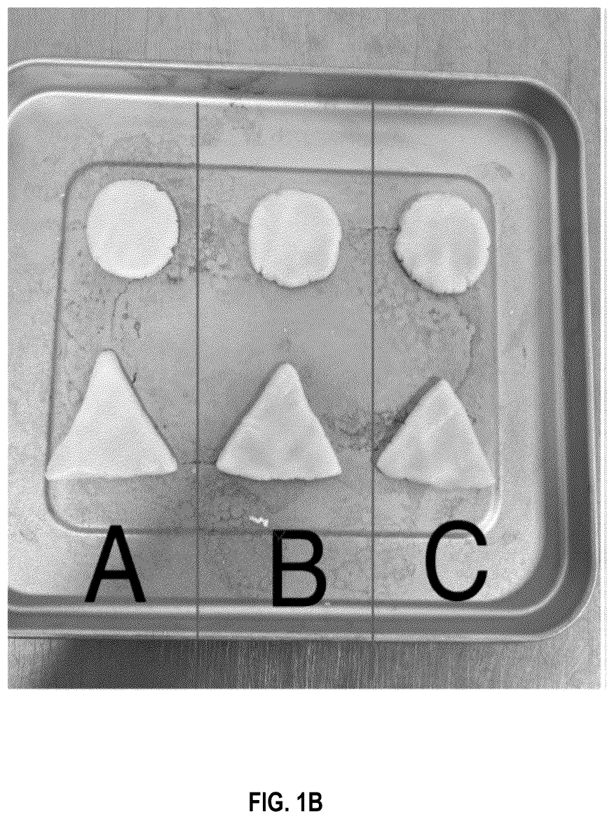

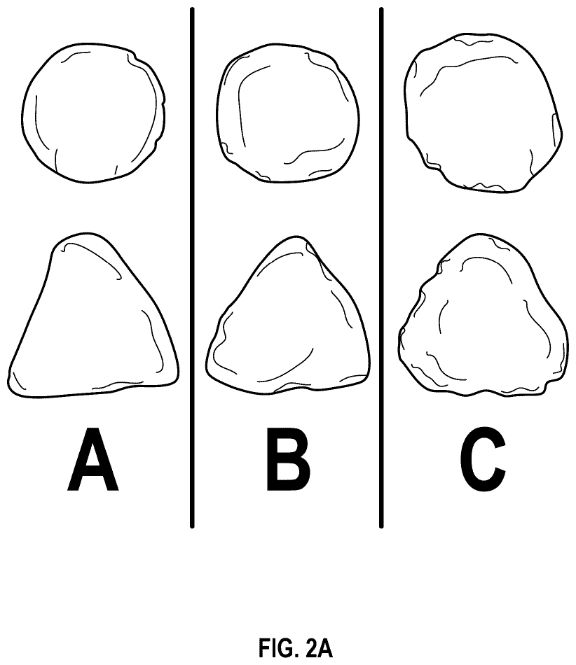

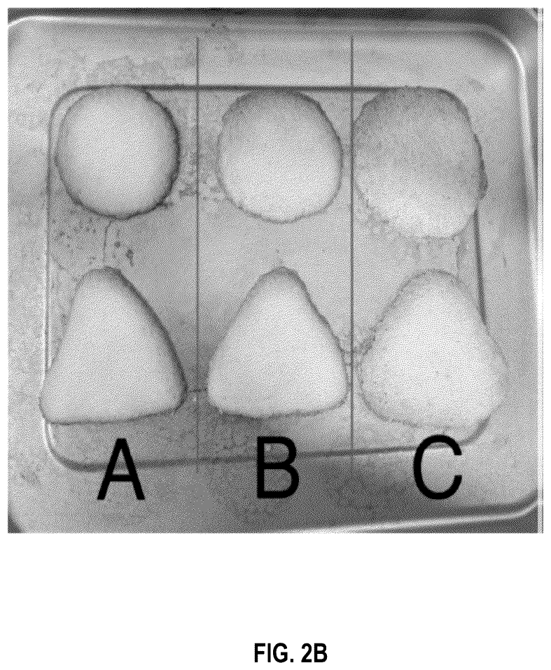

To illustrate the impact of properly selecting the fat and shortening content within a critical range, and the impact during the baking of the cookie dough, three doughs with different fat and shortening blends were prepared. These doughs are illustrated in FIGS. 1A and 1B. The dough A contains about 14% shortening and fat, dough B contains about 18% shortening and fat, and dough C contains about 22% shortening and fat. In doughs A, B and C, all of the materials other than the shortening and fat are maintained as being consistent, and made in the same manner. FIGS. 1A and 1B illustrate doughs A, B and C before baking, whereas FIGS. 2A and 2B illustrate doughs A, B and C after baking. at 165 degrees Celsius for about 15 minutes in an oven.

As is shown in FIGS. 1A-1B, the shape of the doughs appears to be the same prior to baking. However, as shown in FIGS. 2A-2B, the impact of having a proper percentage of shortening and fat can be seen. The baked version of dough A retains its shape after firing, whereas dough B has a slightly dull impression. As for dough C, the shape of the dough is not maintained (e.g., triangle dough becomes rounded, and round dough becomes oval and deshaped).

### Working Example 2

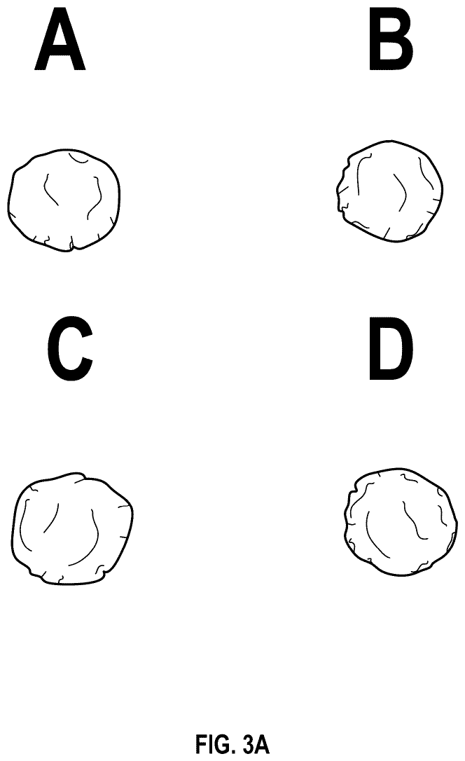

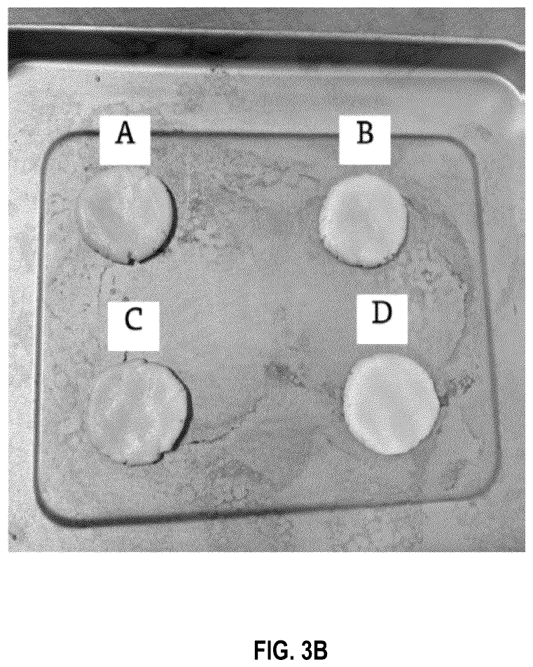

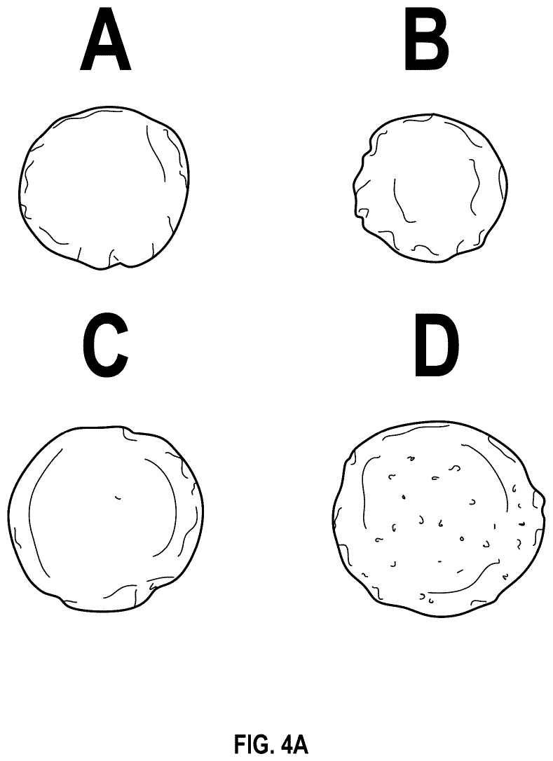

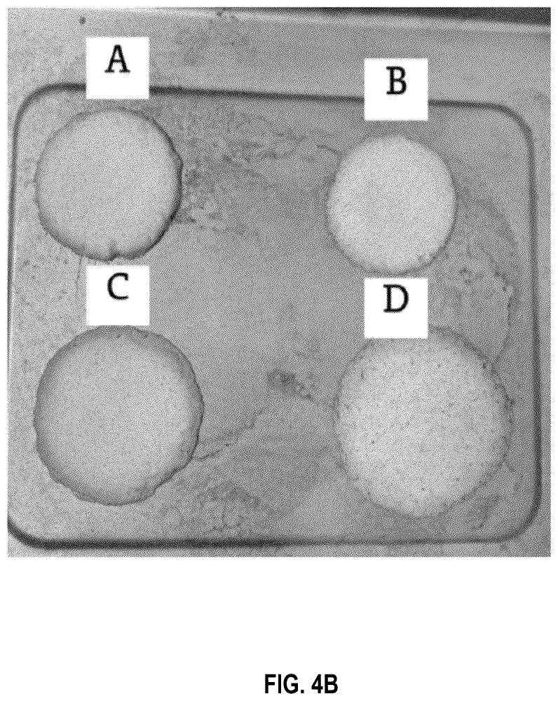

To illustrate the criticality of the proportion of shortening used in the cookie dough, and to demonstrate the impact on the spread of the dough after heating, the working examples shown in FIGS. 3A-3B and 4A-4B were produced.

More specifically, doughs containing four different shortening contents were prepared, and the spread of the doughs after heating was compared. Dough A is 14% shortening, dough B is 17% shortening, dough C is 20% shortening and dough D is 21% shortening, as a proportion of the total amount of dough. As shown in FIGS. 3A and 3B, all of the dough samples A-D have a mass of 10 g and are molded into a circle shape with a diameter of 4 cm.

As shown in FIGS. 3A-3B and 4A-4B, the doughs A-D are baked for 10 minutes at 175 degrees Celsius. While the difference between the spread of doughs A and B (14% and 17% shortening, respectively) is relatively minimal (e.g., the doughs maintain their shape), there is a significant change in the spread of the doughs C and D (e.g., 20% and 21% shortening, respectively). The diameter of each dough after firing is A (5 cm), B (5.2 cm), C (6 cm), and D (7 cm).

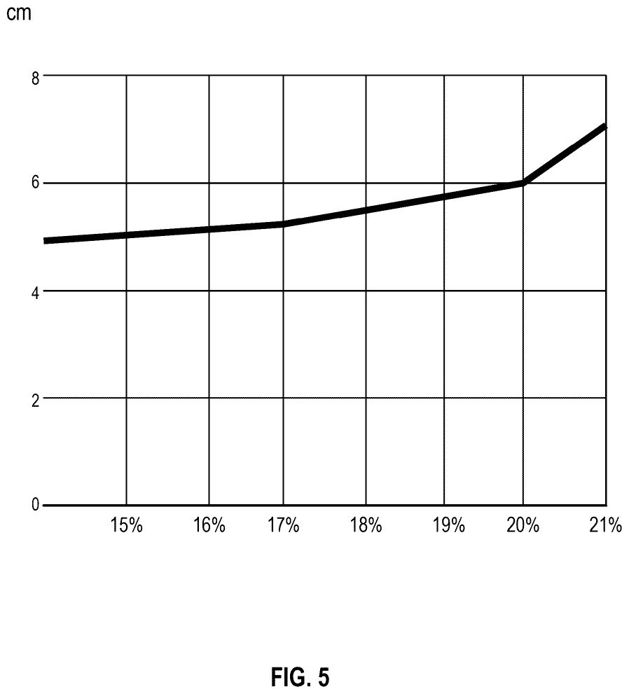

FIG. 5 illustrates the criticality of the shortening concentration. More specifically, FIG. 5 illustrates a relationship between dough spread and percent of shortening. The increase is dough spread is relatively consistent and linear from 15% to 17%, and then from 17% to 20%. However, beyond 20%, there are a sharp increase in the spread of the dough. Further, as can be seen qualitatively, the texture and consistency of the dough is also not maintained, as pores appear and the edge becomes brittle and browned, as compared with the center.

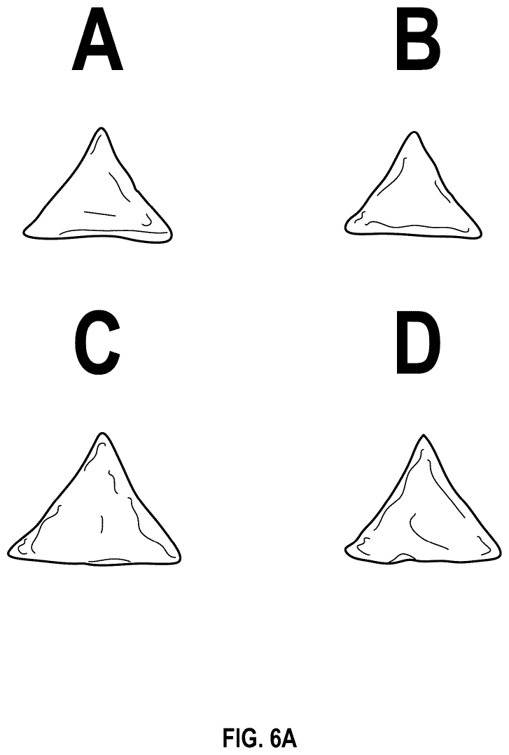

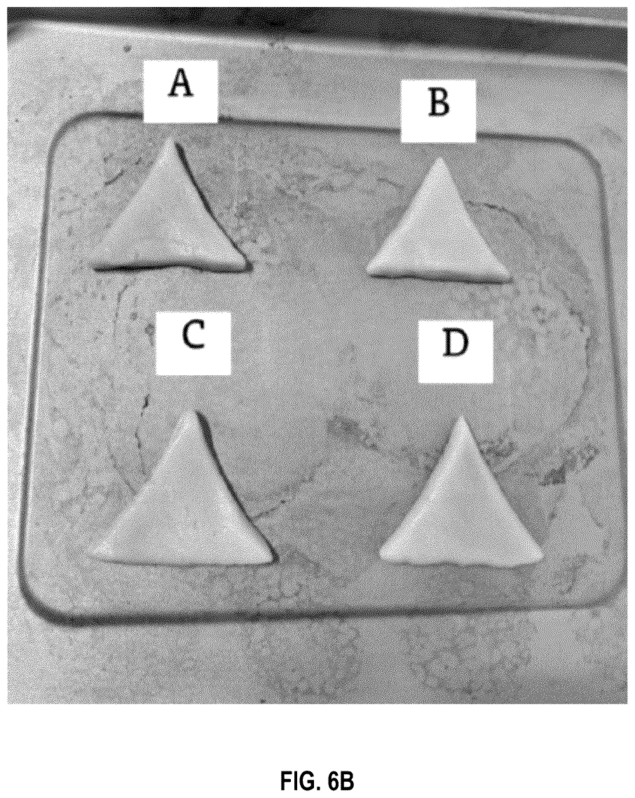

As a variation of Working Example 2, the above-noted doughs A-D were prepared, in a triangular shape, to replicate the impact of molding (e.g., playing with the dough at room temperature). As shown in FIGS. 6A and 6B, doughs A-D were made as triangles, having a mass of 10 g.

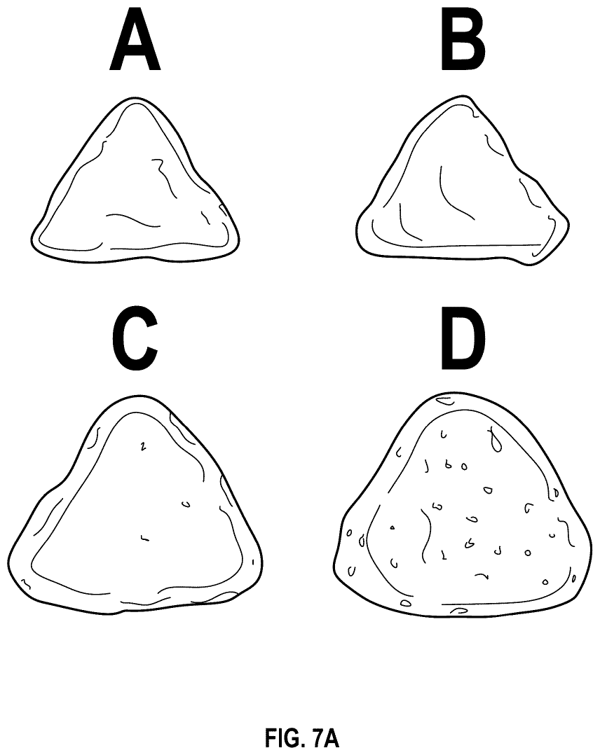

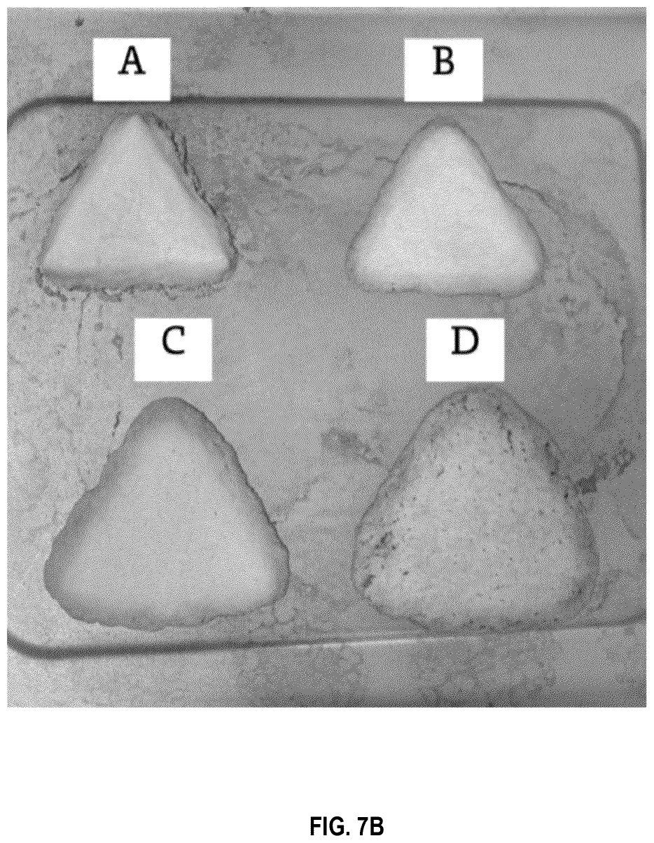

As can be seen in FIGS. 7A and 7B, the dough is baked in the same manner as explained above with respect to FIGS. 3A-3B and 4A-4B. More specifically, the spread between doughs A and B is relatively minimal (e.g., between 14% and 17% shortening content). Further, the original triangular pattern is essentially retained. Further, dough C, has rounded corners, and there is a drastic difference in the spread between dough C (triangle shaped) and dough D (rounded, brittle, porous). Again, when the percent of shortening is greater than 20%, the baking process results in a cookie that does not maintain the original shape, and is degraded in various properties as explained above.

The example implementation may be provided as a ready-to-bake cookie dough. The cookie dough may be baked in an over or a toaster prior to consumption, although it may be eaten raw. Further, while the cookie dough is shelf stable, it may also be stored in a refrigerator. To increase moldability that is insufficient for the desired purpose of the user, a small amount of free water may optionally be added.

The foregoing example implementations include a cookie dough that is storage-stable, allergen-free, and moldable. Thus, the example implementations are not limited to use of the dough solely for storage at room temperature followed by cooking. Because the cookie dough remains stable for a relatively long period (e.g., 3 months to 6 months, or more), the cookie dough may be used as a toy. More specifically, the cookie dough may be stored in one can, or may include a plurality of colors, each stored in a separate can. Because the cookie dough is allergen-free and nut-free, it may be provided for use in groups, such as classrooms of children, to provide an edible, moldable toy without risk of allergy reaction.

Similarly, the edible, moldable dough may be provided in an environment with limited air circulation. For example but not by way of limitation, the example implementation may be provided on a flight, as a toy for children to play with and then eat as a snack, or provide to a flight attendant to be baked, and then returned to the children to be eaten in a baked form. Because there are no nuts in the cookie dough, there is no risk of allergic reaction by another passenger due to nut exposure.

The example implementation may be used as explained herein. More specifically, a user may use the cookie dough to make a shape (e.g., wash hands, knead the dough, and then place the dough in a cup or a mold to form the shape). For example but not by way of limitation, the user may use a molding having a diameter of about 2.5-5.0 cm, and a thickness of 5 mm. However, other thicknesses and diameters may be used, and other shapes may be employed for a mold.

Accordingly, the example implementations are moldable, and can be used to play with the cookie dough. Related art approaches to edible cookie dough that include traditional flour have various problems and disadvantages. For example, but not by way of limitation, the more gluten is kneaded, the more viscous it becomes and the harder it is to bake. With gluten-free dough, the person playing with the dough may avoid the related art problem of the dough becoming too hard (e.g., child unconsciously kneading too much and the baked goods becoming hard), which is perfect for “play”. Similarly, the absence of free water also avoids the related art problems (e.g., spoilage), as described above.

Once the dough has been kneaded and molded, it may be consumed, or it may be baked. For example, and depending on the oven or toaster, the dough make be baked for 8-15 minutes, preferably 10 minutes, at a temperature of 350 F. Once the baking is completed and the cookies have cooled, they may be consumed.

According to an example implementation, the ingredients may include organic rice flower, organic potato starch, organic tapioca flour, organic palm oil, organic Cream of Tartar, organic unrefined sunflower seed oil, organic rice bran syrup (organic brown rice, without or with pure filtered water), organic honey, organic tapioca syrup, sunflower lecithin, xanthan gum, guar gum, sea salt, natural flavors and natural food coloring. While the foregoing ingredients are disclosed to be used, other ingredients may be substituted therefor, as would understood by those skilled in the art. For example but not by way of limitation, a substitute may be used for xanthan gum.

For example but not by way of limitation, the natural food coloring may include garbanzo beans (yellow), cocoa (brown), green tea (green), beet (red), butterfly pea (blue), or purple sweet potato (purple). The color may be provided by mixing plant-based liquids or powders into the dough at the time of manufacture.

The foregoing example implementations may have various advantages and benefits, as distinguished from the related art. For example, but not by way of limitation, the foregoing example implementations do not include coconut oil, which is an allergen for some people.

Further, instead of using sugar for the syrup, the example implementations may include agave syrup, tapioca syrup or rice syrup, as explained above. As honey is not used, the example implementations may be characterized as vegan.

Additionally, the related art approaches include flaxseed and free water as a substitute for eggs. However, the related art approach includes free water. As explained above, the inclusion of free water results has various problems and disadvantages. According the to the present example implementations, free water is excluded from the cookie dough and instead, the aforementioned syrup is used.

Also, for the thickening agent, the example implementations use guar gum at a 2:8 ratio, while the related art uses xanthan gum. This difference is critical, because the guar gum provides a substantially higher viscosity, especially when considering the synergistic impact with the other ingredients.

According to the example implementations the playable dough may be manufactured by the following process. First, the syrup, vinegar and gum powder are mixed. This mixture is provided to increase the viscosity of the mixture. Accordingly, the resulting mixture provides a substitute for the related art free water.

Second, the shortening and lecithin is added to the mixture that was produced in the above process. By adding the shortening and lecithin to the mixture of the first step, emulsification is provided.

Third, the GF flour and any remaining ingredients (e.g., color or flavor) may be added. The resulting dough does not include sugar, but instead uses the above-explained sugar (e.g., to provide a cookie that does not include refined sugar).

Optionally, the playable dough may be edible prior to any baking. For example, but not by way of limitation, the GF flour may be fried prior to the mixing. According to this example implementation, the dough is not only playable, but also edible prior to baking.

In contrast to the related art process of mixing oil and free water to emulsify, followed by adding flour to the emulsified mixture, the foregoing process produces the playable dough according to the example implementations.

In addition to the foregoing example implementation, another example implementation may be provided as follows.

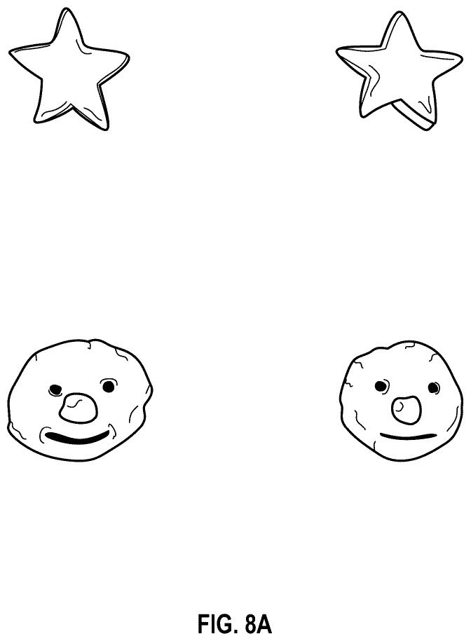

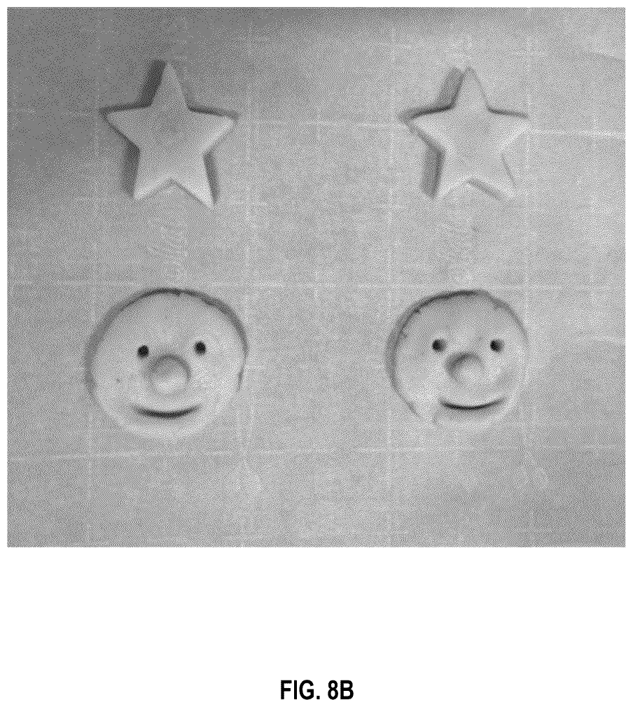

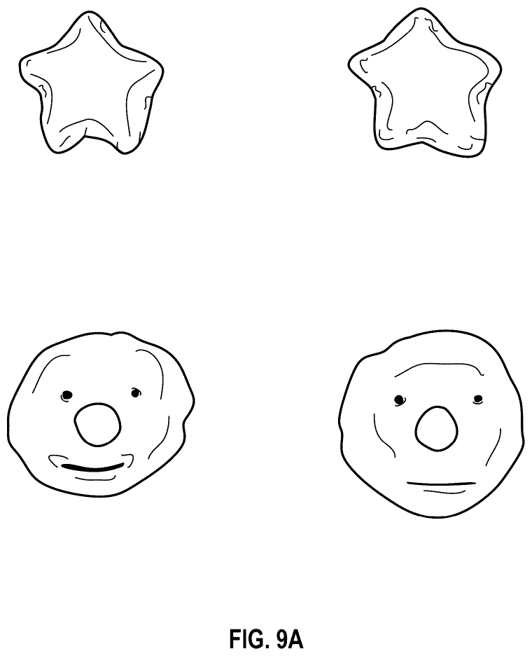

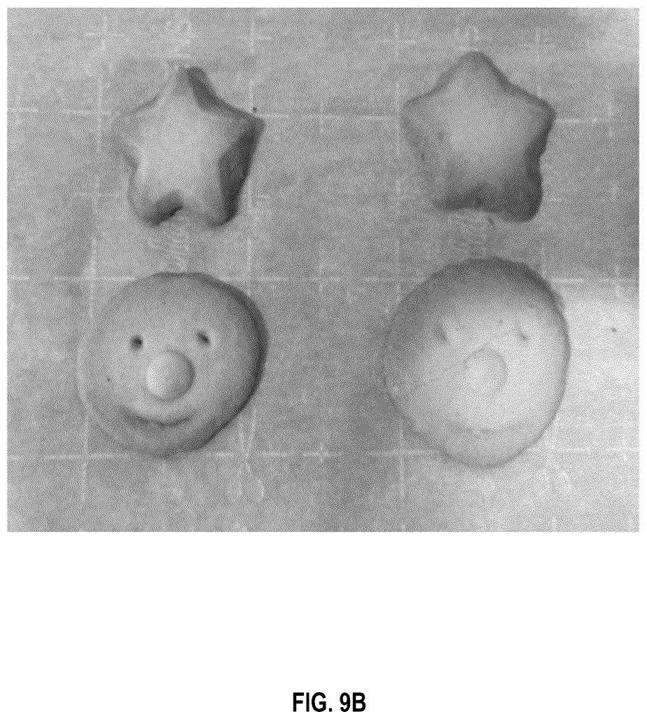

FIGS. 8A and 8B illustrates Working Example 3 in accordance with a second example implementation in unbaked form, FIGS. 9A and 9B illustrates Working Example 3 in accordance with an example implementation in baked form. On the left side, the dough is made as explained above, with a shortening content of 22 percent, and including vinegar. On the right side, the dough is made as explained above, with a shortening content of 22 percent, but without vinegar. If the concentration of shortening is less than about 22 percent, additional syrup may be required, which would increase the amount of free water.

For example, but not by way of limitation, the concentration of vinegar according to this example implementation may be 0.00943396, or 0.943396% by weight. More generally, the vinegar is less than about 1% by weight, as vinegar greater than this amount causes the dough to have an undesirable smell and/or taste of the vinegar. While the vinegar may include free water, the presence of the free water is offset by replacing syrup with cane sugar. Thus, the example implementations continue to minimize the free water in the dough, for the reasons explained above, so as to permit the dough to be stored at room temperature.

By using the above-noted proportions, the free water can be minimized, while having the benefits of the vinegar (e.g., dough feels less oily when being handled or kneaded). Additional benefits may include, but are not limited to, improved shape retention, better maintenance of the coloration (e.g., fabric bleaching), non-oily surface feel, and reduction of free water to below 0.65, which leads to improved shelf life at room temperature.

As can be seen in Working Example 3 in FIGS. 8A and 8B, the dough in unbaked form that includes the vinegar has slightly better kneadability. This can be visualized by the cracking at the edge of the face-shaped dough in the bottom right. As can be seen in FIGS. 9A and 9B, the shape is clearly maintained on the left side, and deformed on the right side. As the sole difference between the dough on the left and right side is the presence of vinegar, it is clear that the vinegar is responsible for the difference, both unbaked and baked.

As an optional modification of the foregoing example implementations, the concentration of shortening may be adjusted upward, for further increase in the ability of the dough to be kneaded prior to baking, as well as without degrading the shape after baking.

While the foregoing example implementations are directed to gluten-free flour, shortening (such as palm oil shortening), cane sugar, agave syrup, thickening agents, emulsifiers and salt, the specific materials used therein may be substituted or modified as a matter of design choice, so long as they are consistent with the teachings of the example implementations, as would be understood by those skilled in the art.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

1. A dough configured to be baked by heat, the dough comprising:
a gluten-free cereal flour;
a sweetener;
a shortening; and
an emulsifier,
wherein the dough is shelf-stable, moldable, edible, allergen-free and vegan.

2. The dough of claim 1, wherein the dough does not include TOP14 ingredients.

3. The dough of claim 1, wherein the dough does not include gluten.

4. The dough of claim 1, wherein the percent of shortening is less than 20% of the composition.

5. The dough of claim 4, wherein the percent of shortening is less than 14% to 16% of the composition.

6. The dough of claim 5, wherein the percent of shortening is about 15% of the composition.

7. The dough of claim 1, where in the dough may be formed in one or more of a plurality of colors by blending an organic food coloring in the dough.

8. The dough of claim 1, wherein the dough is configured to be molded in a can.

9. The dough of claim 1, wherein the dough is nut-free.

10. The dough of claim 1, further comprising vinegar.
